(19) United States
(12) Patent Application Publication
(10) Pub. No.: US 2016/0108937 A1
(43) Pub. Date: Apr. 21, 2016

(54) PRESSURE MAINTAINING APPARATUS, MACHINE TOOL, AND METHOD OF RUNNING PRESSURE MAINTAINING APPARATUS IN MACHINE TOOL

(71) Applicant: MITSUBISHI HEAVY INDUSTRIES, LTD., Tokyo (JP)

(72) Inventor: Takayuki KUME, Tokyo (JP)

(73) Assignee: MITSUBISHI HEAVY INDUSTRIES, LTD., Tokyo (JP)

(21) Appl. No.: 14/864,274

(22) Filed: Sep. 24, 2015

(30) Foreign Application Priority Data
Oct. 17, 2014 (JP) 2014-212505

(51) Int. Cl. F15B 11/17

(52) U.S. Cl. CPC F15B 11/17; F15B 2211/20576; F15B 2211/2656; F15B 2211/5158

(57) ABSTRACT

A machine tool includes: a plurality of hydraulic devices including hydraulic balance cylinders; a main hydraulic unit including a main hydraulic pump and a pump motor for supplying hydraulic oil in an operation period; and a pressure-maintaining hydraulic unit connected in parallel to an oil supply line of the main hydraulic unit and including a pressure-maintaining hydraulic pump and a pump motor being smaller in output than the main hydraulic pump and the pump motor. When at least one of the hydraulic devices is operated, the hydraulic oil is supplied from the main hydraulic pump and the pump motor to the hydraulic devices. When all of the hydraulic devices are stopped, the hydraulic oil is supplied from the pressure-maintaining hydraulic pump and the pump motor to the hydraulic device in the standby period to maintain the pressure of the hydraulic oil in the hydraulic device.

### TECHNICAL FIELD

The present invention relates to a pressure maintaining apparatus for maintaining the pressure of hydraulic oil in a standby period, a machine tool, and a method of running a pressure maintaining apparatus in a machine tool.

### BACKGROUND ART

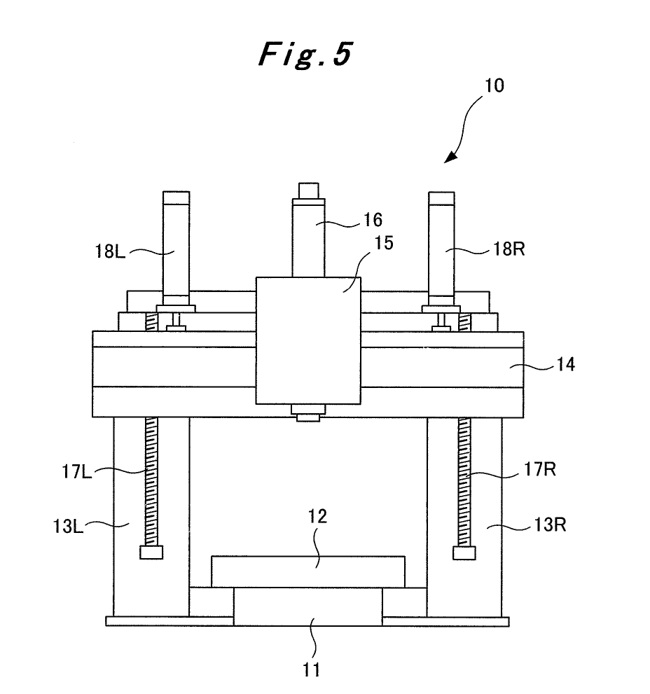

FIG. 5 shows a double-column machine tool. A double-column machine tool 10 (hereinafter, the machine tool 10) includes: a bed 11 placed on a floor surface; a table 12 on which to place an object to be machined (workpiece); two columns 13L, 13R standing upright to the left and right of the bed 11; a cross rail 14 provided to be capable of being vertically moved along vertical slide surfaces of the columns 13L, 13R; a saddle 15 provided to be capable of being horizontally moved along a horizontal slide surface of the cross rail 14; a ram 16 provided to be capable of being vertically moved while being guided by a vertical slide surface of the saddle 15; and the like. Note that reference signs 17L, 17R denote feed shafts for vertically moving the cross rail 14.

In this machine tool 10, the cross rail 14 is deformed when the center of gravity is shifted by horizontal movement of the saddle 15 and the ram 16. To compensate for this shift, there are provided hydraulic balance cylinders 18L, 18R configured to hold opposite end portions of the cross rail 14, and the pressure of each of the hydraulic balance cylinders 18L, 18R is adjusted to adjust the weight balance.

### CITATION LIST

### Patent Literature

[Patent Literature 1] Japanese Patent Application Publication No. Hei 6-277989

### SUMMARY OF INVENTION

### Technical Problem

In the machine tool 10 shown in FIG. 5, a hydraulic unit configured to supply hydraulic oil to the hydraulic balance cylinders 18L, 18R is constantly run to perform pressure maintaining operation so that the hydraulic balance cylinders 18L, 18R holding the cross rail 14 can be prevented from being lowered. Further, since the oil leaks from balance valves, check valves, hydraulic cylinders, and the like in the hydraulic circuit, accumulators are provided to avoid decrease in the strength of the maintaining of the pressure due to the oil leakage.

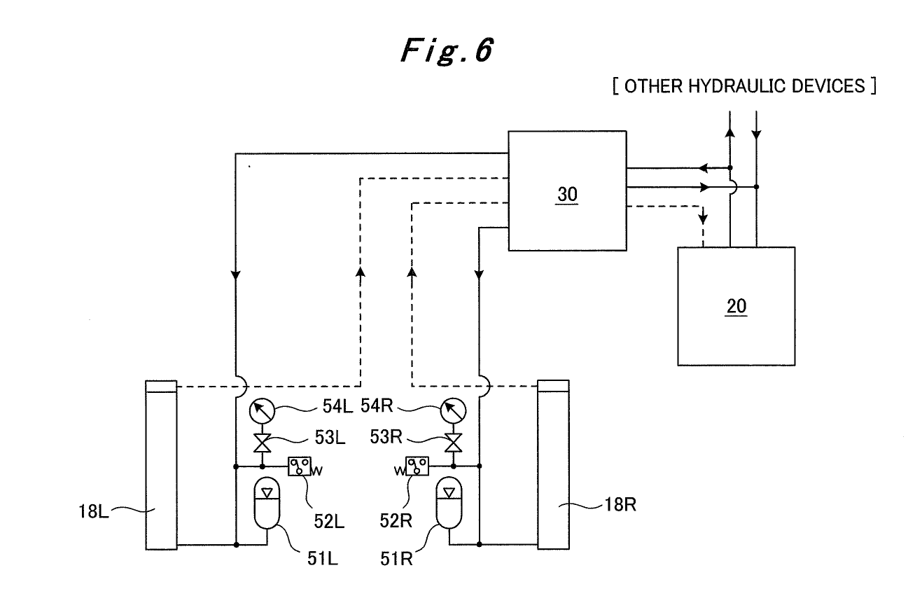

For example, as shown in FIG. 6, the hydraulic oil is supplied to the hydraulic balance cylinders 18L, 18R of the machine tool 10 from a main hydraulic unit 20 through a pressure adjusting unit 30 configured to adjust the balance by means of pressure. Note that the hydraulic oil is supplied also to other hydraulic devices, for example, an automatic attachment changer (AAC), an automatic tool changer (ATC), and the like from the main hydraulic unit 20. Moreover, accumulators 51L, 51R are placed adjacently to the hydraulic balance cylinders 18L, 18R since the oil leaks from balance valves and check valves used in the main hydraulic unit 20, the pressure adjusting unit 30, and the like and from the hydraulic balance cylinders 18L, 18R. Note that reference signs 52L, 52R denote pressure switches, reference signs 53L, 53R denote stop valves, and reference signs 54L, 54R denote pressure gauges. Also, the solid lines show the flow of the hydraulic oil, and the dotted lines show the flow of air.

Although the accumulators 51L, 51R are provided adjacently to the hydraulic balance cylinders 18L, 18R as mentioned above, it is still difficult to avoid the oil leakage from the hydraulic balance cylinders 18L, 18R which extend along the gravity axis. After the pressure maintaining performance of the accumulators 51L, 51R is deteriorated, the main hydraulic unit 20 needs to be run again to perform the pressure maintaining operation. Hence, there is still room for improvement in the reduction of the power consumption in a standby period and energy saving.

The present invention has been made in view of the above problem, and an object thereof is to provide a pressure maintaining apparatus, a machine tool, and a method of running a pressure maintaining apparatus in a machine tool which can reduce the power consumption in a standby period to achieve energy saving.

### Solution to Problem

A pressure maintaining apparatus according to a first aspect for solving the above problem is a pressure maintaining apparatus provided to a main hydraulic apparatus including first supplying means for supplying hydraulic oil to a hydraulic device in an operation period, the pressure maintaining apparatus including second supplying means connected in parallel to an oil supply line of the main hydraulic apparatus and being smaller in output than the first supplying means, in which instead of the first supplying means, the second supplying means supplies the hydraulic oil to the hydraulic device in a standby period to thereby maintain the pressure of the hydraulic oil in the hydraulic device in the standby period.

A machine tool according to a second aspect for solving the above problem is a machine tool, comprising:

an existing machine tool having a plurality of hydraulic devices including a hydraulic device which needs to maintain pressure of hydraulic oil therein in a standby period and a main hydraulic apparatus including first supplying means for supplying the hydraulic oil to the hydraulic devices in an operation period;

the pressure maintaining apparatus according to claim 1 connected in parallel to an oil supply line of the main hydraulic apparatus.

A machine tool according to a third aspect for solving the above problem is the machine tool according to the second aspect, further including a controller configured to control the main hydraulic apparatus and the pressure maintaining apparatus, in which

when any one or more of the plurality of hydraulic devices are operated, the controller stops the second supplying means and operates the first supplying means to thereby supply the hydraulic oil from the first supplying means to the hydraulic devices, and

when all of the plurality of hydraulic devices are stopped, the controller operates the second supplying means instead of the first supplying means to thereby supply the hydraulic oil from the second supplying means to the hydraulic devices and maintain the pressure of the hydraulic oil in the hydraulic devices in the standby period.

A machine tool according to a fourth aspect for solving the above problem is a machine tool, including:

a plurality of hydraulic devices including a hydraulic device which needs to maintain pressure of hydraulic oil therein in a standby period;

a main hydraulic apparatus including first supplying means for supplying the hydraulic oil to the hydraulic devices in an operation period;

a pressure maintaining apparatus connected in parallel to an oil supply line of the main hydraulic apparatus and including second supplying means being smaller in output than the first supplying means; and

a controller configured to control the main hydraulic apparatus and the pressure maintaining apparatus, in which

when any one or more of the plurality of hydraulic devices are operated, the controller stops the second supplying means and operates the first supplying means to thereby supply the hydraulic oil from the first supplying means to the hydraulic devices, and

when all of the plurality of hydraulic devices are stopped, the controller operates the second supplying means instead of the first supplying means to thereby supply the hydraulic oil from the second supplying means to the hydraulic devices and maintain the pressure of the hydraulic oil in the hydraulic devices in the standby period.

A method of running a pressure maintaining apparatus in a machine tool according to a fifth aspect for solving the above problem is a method of running a pressure maintaining apparatus in a machine tool including

a plurality of hydraulic devices including a hydraulic device which needs to maintain pressure of hydraulic oil therein in a standby period,

a main hydraulic apparatus including first supplying means for supplying the hydraulic oil to the hydraulic devices in an operation period, and

a pressure maintaining apparatus connected in parallel to an oil supply line of the main hydraulic apparatus and including second supplying means being smaller in output than the first supplying means, the method including:

when any one or more of the plurality of hydraulic devices are operated, stopping the second supplying means and operating the first supplying means to thereby supply the hydraulic oil from the first supplying means to the hydraulic devices; and

when all of the plurality of hydraulic devices are stopped, operating the second supplying means instead of the first supplying means to thereby supply the hydraulic oil from the second supplying means to the hydraulic devices and maintain the pressure of the hydraulic oil in the hydraulic devices in the standby period.

### Advantageous Effects of Invention

According to the present invention, the pressure maintaining apparatus including the second supplying means with small output is connected in parallel to the oil supply line of the main hydraulic apparatus including the first supplying means, and the hydraulic oil is supplied to the hydraulic device in the standby period from the second supplying means instead of from the first supplying means to thereby maintain the pressure of the hydraulic oil in the hydraulic device in the standby period. In this way, it is possible to reduce the power consumption in the standby period and thus achieve energy saving.

Moreover, the present invention is easily applicable to an existing machine tool including hydraulic devices such as hydraulic balance cylinders which need to maintain the pressure of hydraulic oil therein in a standby period. By using the present invention, it is possible to reduce the power consumption of the existing machine tool in the standby period and thus save the energy consumed by the machine tool.

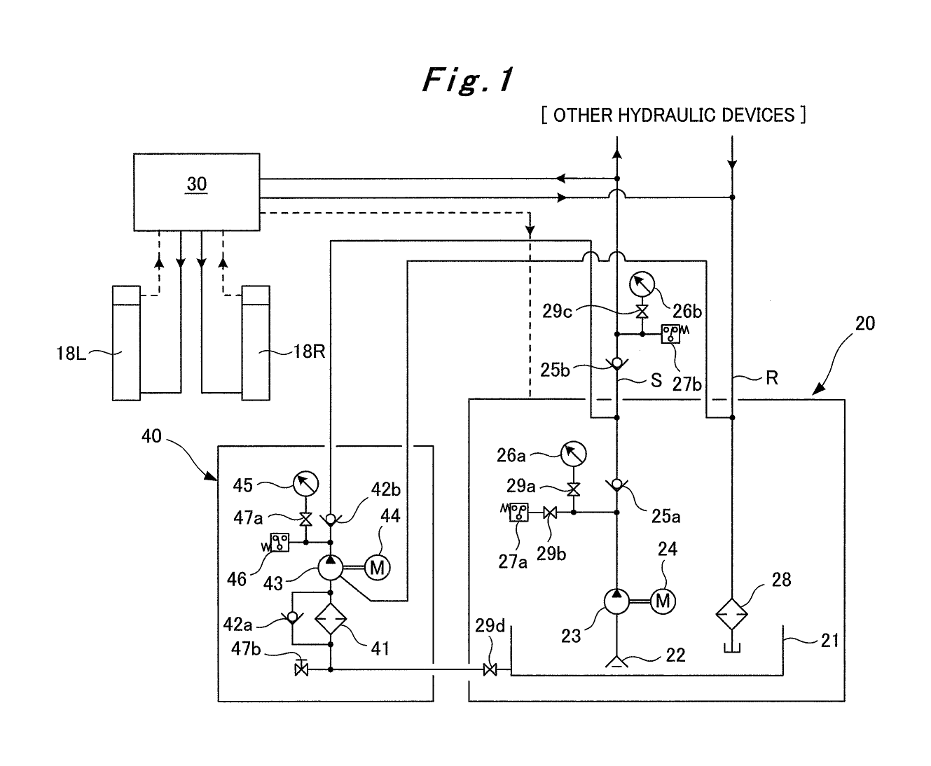

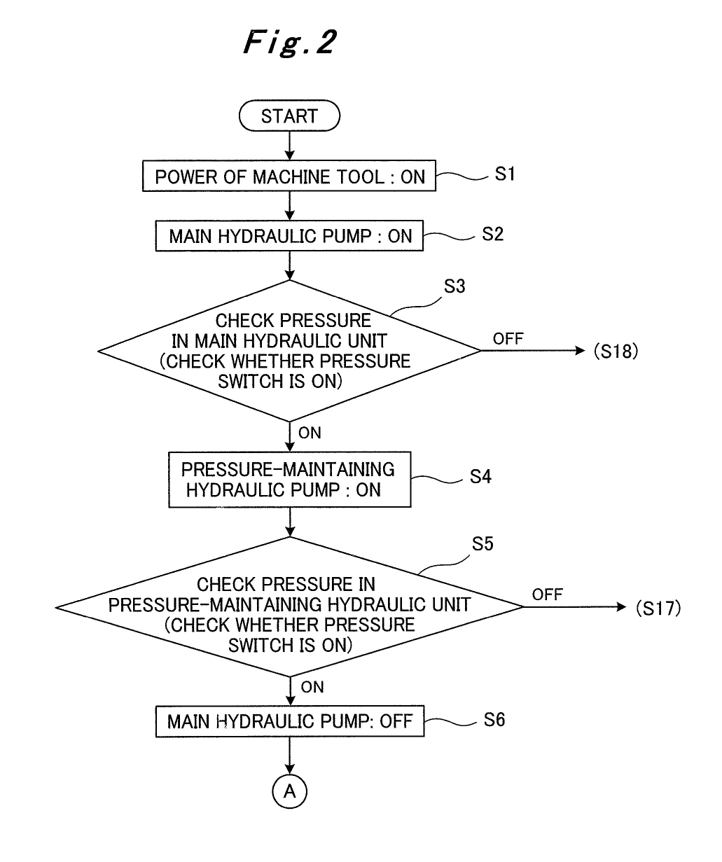

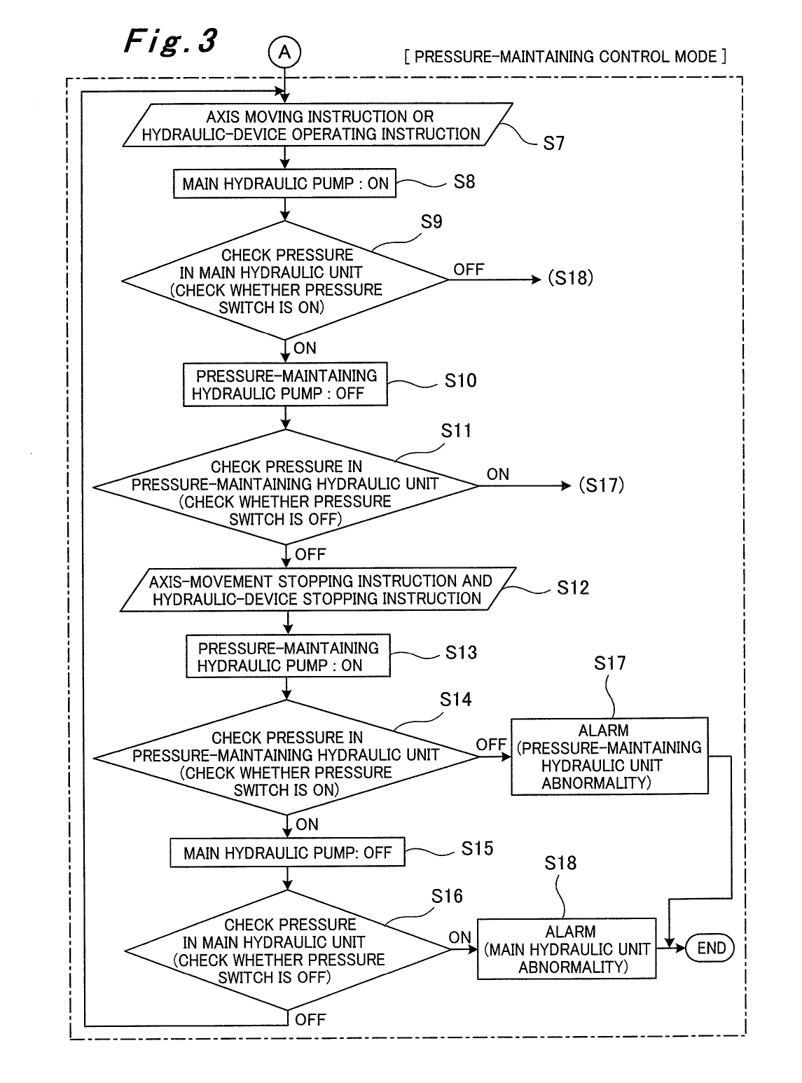

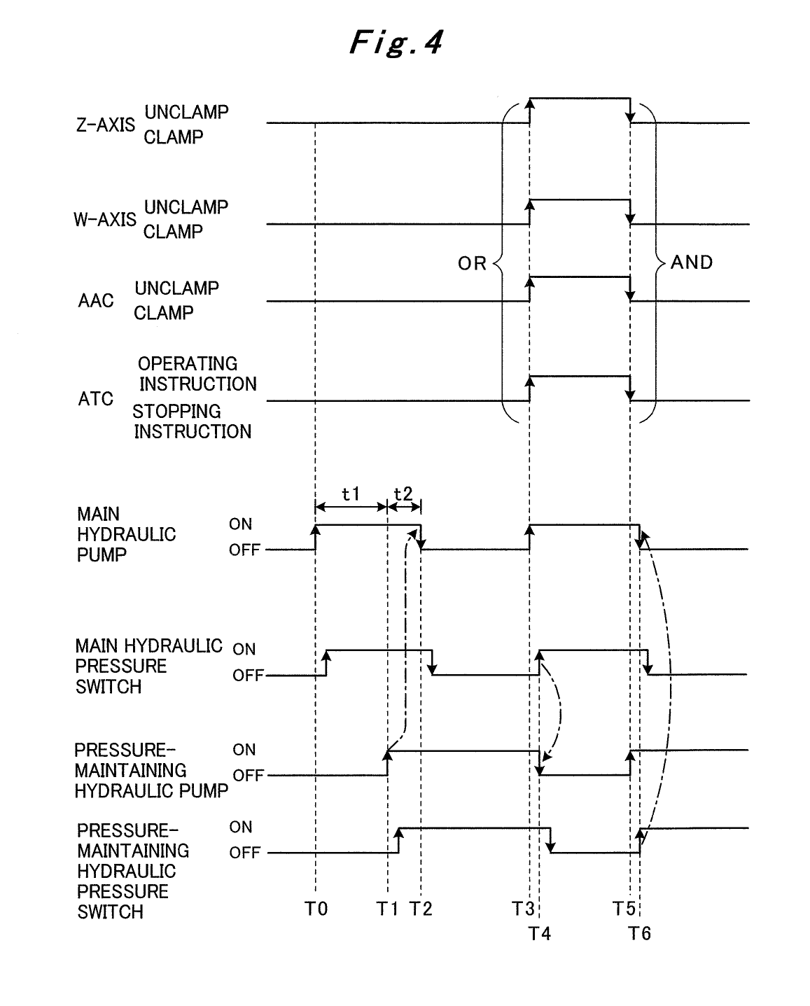

### [BRIEF DESCRIPTION OF DRAWINGS]

[FIG. 1]FIG. 1 is a hydraulic system diagram showing an exemplary embodiment of a pressure maintaining apparatus according to the present invention.

[FIG. 2]FIG. 2 is the first half of a flowchart describing the operation of the pressure maintaining apparatus shown in FIG. 1.

[FIG. 3]FIG. 3 is the second half of the flowchart describing the operation of the pressure maintaining apparatus shown in FIG. 1.

[FIG. 4]FIG. 4 is a timing chart describing the operation of the pressure maintaining apparatus shown in FIG. 1.

[FIG. 5]FIG. 5 is a schematic view showing a double-column machine tool.

[FIG. 6]FIG. 6 is a hydraulic system diagram showing a hydraulic apparatus including accumulators.

### DESCRIPTION OF EMBODIMENT

An embodiment of a pressure maintaining apparatus according to the present invention will be described below with reference to FIGS. 1 to 4. It is to be noted that a machine tool will be described here with reference to the double-column machine tool including the hydraulic balance cylinders shown in FIG. 5, but a machine tool with a different structure may be employed as long as it includes hydraulic devices which need to maintain the pressure of hydraulic pressure therein in a standby period like the hydraulic balance cylinders mentioned above.

### Embodiment 1

FIG. 1 is a hydraulic system diagram showing the pressure maintaining apparatus of this embodiment. Moreover, FIGS. 2 and 3 are a flowchart describing the operation of the pressure maintaining apparatus shown in FIG. 1, and FIG. 4 is a timing chart describing the operation of the pressure maintaining apparatus shown in FIG. 1.

A pressure-maintaining hydraulic unit 40 (pressure maintaining apparatus) of this embodiment is configured to be capable of being added to an existing main hydraulic unit 20 (main hydraulic apparatus) and, like the conventional practice, capable of supplying hydraulic oil to hydraulic balance cylinders 18L, 18R of a machine tool 10 through a pressure adjusting unit 30 configured to adjust the balance by means of pressure.

The configuration of the main hydraulic unit 20 will be described with reference to FIG. 1. The main hydraulic unit 20 includes: an oil tank 21 configured to store the oil therein; a strainer 22 through which to suck the oil from the oil tank 21 while removing solid components; a main hydraulic pump 23 (first supplying means) configured to supply the oil sucked from the oil tank 21; a pump motor 24 (first supplying means) configured to drive the main hydraulic pump 23; a check valve 25a configured to prevent back flow of the oil supplied from the main hydraulic pump 23; a pressure gauge 26a connected through a stop valve 29a and configured to measure the pressure of the oil supplied from the main hydraulic pump 23; and a pressure switch 27a connected through a stop valve 29b and configured to detect whether or not the pressure of the oil supplied from the main hydraulic pump 23 is equal to or higher than a predetermined pressure.

With the above configuration, the hydraulic oil is supplied through an oil supply line S to the pressure adjusting unit 30, the hydraulic balance cylinders 18L, 18R, other hydraulic devices (AAC,ATC), and the like in their operation period.

A check valve 25b is connected to the oil supply line S. Further, the oil supply line S is provided with a pressure gauge 26b connected thereto through a stop valve 29c and configured to measure the pressure of the hydraulic oil to be supplied to each hydraulic device, and a pressure switch 27b configured to detect whether or not the pressure of the hydraulic oil to be supplied to each hydraulic device is equal to or higher than a predetermined pressure.

Meanwhile, the hydraulic oil returning from the pressure adjusting unit 30, the hydraulic balance cylinders 18L, 18R, the other hydraulic devices (AAC, ATC), and the like through an oil return line R is filtered by a filter 28 provided in the main hydraulic unit 20 and returns into the oil tank 21.

The pressure-maintaining hydraulic unit 40 is connected in parallel to the main hydraulic unit 20. Specifically, the pressure-maintaining hydraulic unit 40 is connected in parallel to the oil supply line S and the oil return line R and connected to the oil tank 21 through a stop valve 29d, and is configured to be capable of sucking the oil in the oil tank 21 through the stop valve 29d.

This pressure-maintaining hydraulic unit 40 includes: a filter 41 configured to filter the oil sucked from the oil tank 21; a check valve 42a connected in parallel to the filter 41 and configured to prevent back flow of the oil sucked from the oil tank 21; a pressure-maintaining hydraulic pump 43 (second supplying means) configured to supply the oil sucked from the oil tank 21; a pump motor 44 (second supplying means) configured to drive the pressure-maintaining hydraulic pump 43; a check valve 42b configured to prevent back flow of the oil supplied from the pressure-maintaining hydraulic pump 43; a pressure gauge 45 connected through a stop valve 47a and configured to measure the pressure of the oil supplied from the pressure-maintaining hydraulic pump 43; and a pressure switch 46 configured to detect whether or not the pressure of the oil supplied from the pressure-maintaining hydraulic pump 43 is equal to or higher than a predetermined pressure. Here, a stop valve 47b is provided for draining.

With the above configuration, the hydraulic oil can be supplied through the oil supply line S to the pressure adjusting unit 30, the hydraulic balance cylinders 18L, 18R, the other hydraulic devices (AAC, ATC), and the like in their standby period. Meanwhile, the pressure-maintaining hydraulic pump 43 is connected to the oil return line R of the main hydraulic unit 20 so as to be able to suck the returning oil.

Here, the output of the pressure-maintaining hydraulic pump 43 and the pump motor 44 is used in the standby period where each hydraulic device is not operated, and may therefore be significantly smaller than the output of the main hydraulic pump 23 and the pump motor 24. Accordingly, the power consumption of the pressure-maintaining hydraulic pump 43 and the pump motor 44 is also significantly smaller than the power consumption of the main hydraulic pump 23 and pump motor 24. For example, in the case where the power consumption of the main hydraulic pump 23 and pump motor 24 in the main hydraulic unit 20 needs to be 15 kW or higher, the power consumption of the pressure-maintaining hydraulic pump 43 and pump motor 44 in the pressure-maintaining hydraulic unit 40 only needs to be 1.5 kW or lower, which is only a one-tenth or less power consumption.

As described above, the machine tool 10 includes the pressure-maintaining hydraulic unit 40 in addition to the existing main hydraulic unit 20. Moreover, as will be described later, the main hydraulic unit 20 is used when the hydraulic devices are in the operation period, whereas the pressure-maintaining hydraulic unit 40 is used while the hydraulic devices are in the standby period.

Next, the operation of the main hydraulic unit 20 and the pressure-maintaining hydraulic unit 40 will be described with reference to the flowchart in FIGS. 2 and 3 and the timing chart in FIG. 4 along with FIG. 1. Note that, a Z-axis device (ram), a W-axis device (cross rail), the AAC, and the ATC are shown as examples of the hydraulic devices in the timing chart in FIG. 4. Also, the operation to be described below is performed by a controller not shown which is provided to the pressure-maintaining hydraulic unit 40, for example, and the controller is configured to operate upon receipt of predetermined signals from the machine tool 10.

(Steps S1 and S2)

The power of the machine tool 10 is turned on. As a result, the main hydraulic pump 23 is turned on (time TO in the timing chart in FIG. 4), that is, the power of the pump motor 24 of the main hydraulic pump 23 is turned on.

(Step S3)

After the main hydraulic pump 23 is turned on, the pressure of the oil in the main hydraulic unit 20 is checked. Specifically, the pressure switch 27a is used to detect whether or not the pressure of the oil supplied from the main hydraulic pump 23 is equal to or higher than the predetermined pressure. If the pressure is equal to or higher than the predetermined pressure, that is, if the pressure switch 27a is on, the controller proceeds to step S4. If the pressure is lower than the predetermined pressure, that is, if the pressure switch 27a is off, the controller proceeds to step S18 and displays an alarm (main hydraulic unit abnormality).

(Step S4)

If the pressure switch 27a is on, the pressure-maintaining hydraulic pump 43 is turned on, that is, the power of the pump motor 44 of the pressure-maintaining hydraulic pump 43 is turned on, after the elapse of a predetermined period of time t1 (time T1 in the timing chart in FIG. 4). This predetermined period of time t1 may be set by means of a variable timer or the like and is set at 60 seconds, for example.

(Step S5)

After the pressure-maintaining hydraulic pump 43 is turned on, the pressure of the oil in the pressure-maintaining hydraulic unit 40 is checked. Specifically, the pressure switch 46 is used to detect whether or not the pressure of the oil supplied from the pressure-maintaining hydraulic pump 43 is equal to or higher than the predetermined pressure. If the pressure is equal to or higher than the predetermined pressure, that is, if the pressure switch 46 is on, the controller proceeds to step S6. If the pressure is lower than the predetermined pressure, that is, if the pressure switch 46 is off, the controller proceeds to step S17 and displays an alarm (pressure-maintaining hydraulic unit abnormality).

(Step S6)

If the pressure switch 46 is on, the main hydraulic pump 23 is turned off after the elapse of a predetermined period of time t2 (time T2 in the timing chart in FIG. 4). This predetermined period of time t2 may also be set by means of a variable timer or the like and is set at one second, for example.

Steps S1 to S6 described above are performed as an initial operation check. If there is no abnormality, the main hydraulic pump 23 is turned off and a pressure-maintaining control mode starts. The period between the time T2 and a later-mentioned time T3 is the standby period during which the pressure-maintaining hydraulic unit 40 maintains the pressure to prevent lowering of the above-mentioned hydraulic balance cylinders 18L, 18R and the like, for example.

(Steps S7 and S8)

In the pressure-maintaining control mode, the main hydraulic pump 23 is turned on when an operating instruction is issued to at least one of the hydraulic devices that use the hydraulic oil (time T3 in the timing chart in FIG. 4). For example, the main hydraulic pump 23 is turned on when an operating instruction is issued to any one or more of the hydraulic devices mentioned below.

(1a) axis moving instruction

(2a) Z-axis/W-axis shaft-clamp-device unclamping instruction

(3a) hydraulic-device (AAC, ATC, pallet changer, etc.) operating instruction

(4a) hydraulic-device manually manipulating instruction

(5a) coolant-guard/safety-guard operating instruction

In the timing chart shown in FIG. 4, the main hydraulic pump 23 is turned on when any one of operating instructions, namely, the Z-axis shaft-clamp-device unclamping instruction, W-axis shaft-clamp-device unclamping instruction, AAC operating instruction (unclamping instruction), and ATC operating instruction is issued (OR condition).

The period between the time T3 and a later-mentioned time T5 is the operation period during which the main hydraulic unit 20 supplies the hydraulic oil and the hydraulic devices such as the AAC and the ATC as mentioned above operate.

(Step S9)

After the main hydraulic pump 23 is turned on, the pressure of the oil in the main hydraulic unit 20 is checked by using the pressure switch 27a to detect whether or not the pressure of the oil supplied from the main hydraulic pump 23 is equal to or higher than the predetermined pressure. If the pressure is equal to or higher than the predetermined pressure, that is, if the pressure switch 27a is on, the controller proceeds to step S10. If the pressure is lower than the predetermined pressure, that is, if the pressure switch 27a is off, the controller proceeds to step S18 and displays an alarm (main hydraulic unit abnormality).

(Step S10)

If the pressure switch 27a is on, the pressure-maintaining hydraulic pump 43 is turned off (time T4 in the timing chart in FIG. 4).

(Step S11)

After the pressure-maintaining hydraulic pump 43 is turned off, the pressure of the oil in the pressure-maintaining hydraulic unit 40 is checked by using the pressure switch 46 to detect whether or not the pressure of the oil has dropped to be lower than the predetermined pressure. If the pressure is lower than the predetermined pressure, that is, if the pressure switch 46 is off, the controller proceeds to step S12. If the pressure is equal to or higher than the predetermined pressure, that is, if the pressure switch 46 is on, the controller proceeds to step S17 and displays an alarm (pressure-maintaining hydraulic unit abnormality).

By stopping the pressure-maintaining hydraulic unit 40 once the main hydraulic unit 20 is operated as described above, the operation is switched from the pressure-maintaining hydraulic unit 40 to the main hydraulic unit 20, that is, the main hydraulic pump 23 and the pump motor 24 are operated instead of the pressure-maintaining hydraulic pump 43 and the pump motor 44 to thereby supply the hydraulic oil from the main hydraulic pump 23 and the pump motor 24 and thus supply the hydraulic oil to the hydraulic device(s) in the operation period. This switching of the operation may be automatically performed upon receipt of the operating instructions (1a) to (5a) mentioned above. Alternatively, the switching of the operation may be automatically performed by monitoring the pressure in the oil supply line S and detecting when this pressure drops to be lower than the predetermined pressure, that is, when the pressure switch 27b is turned off.

(Steps S12 and S13)

In the pressure-maintaining control mode, the pressure-maintaining hydraulic pump 43 is turned on when a stopping instruction is subsequently issued to all the hydraulic devices that use the hydraulic oil (time T5 in the timing chart in FIG. 4). For example, the pressure-maintaining hydraulic pump 43 is turned on when a stopping instruction is issued to all the hydraulic devices mentioned below.

(1b) axis-movement stopping instruction

(2b) Z-axis/W-axis shaft-clamp-device clamping instruction

(3b) hydraulic-device (AAC, ATC, pallet changer, etc.) stopping instruction

(4b) absence of hydraulic-device manually manipulating instruction

(5b) coolant-guard/safety-guard stopping instruction

In the timing chart shown in FIG. 4, the pressure-maintaining hydraulic pump 43 is turned on when all the stopping instructions, namely, the Z-axis shaft-clamp-device clamping instruction, W-axis shaft-clamp-device clamping instruction, AAC stopping instruction (clamping instruction), and ATC stopping instruction are issued (AND condition).

(Step S14)

After the pressure-maintaining hydraulic pump 43 is turned on, the pressure of the oil in the pressure-maintaining hydraulic unit 40 is checked by using the pressure switch 46 to detect whether or not the pressure of the oil supplied from the pressure-maintaining hydraulic pump 43 is equal to or higher than the predetermined pressure. If the pressure is equal to or higher than the predetermined pressure, that is, if the pressure switch 46 is on, the controller proceeds to step S15. If the pressure is lower than the predetermined pressure, that is, if the pressure switch 46 is off, the controller proceeds to step S17 and displays an alarm (pressure-maintaining hydraulic unit abnormality).

(Step S15)

If the pressure switch 46 is on, the main hydraulic pump 23 is turned off (time T6 in the timing chart in FIG. 4).

(Step S16)

After the main hydraulic pump 23 is turned off, the pressure of the oil in the main hydraulic unit 20 is checked by using the pressure switch 27a to detect whether or not the pressure of the oil has dropped to be lower than the predetermined pressure. If the pressure is lower than the predetermined pressure, that is, if the pressure switch 27a is off, the controller returns to step S7 and maintains the pressure-maintaining control mode. If the pressure is equal to or higher than the predetermined pressure, that is, if the pressure switch 27a is on, the controller proceeds to step S18 and displays an alarm (main hydraulic unit abnormality).

By stopping the main hydraulic unit 20 once the pressure-maintaining hydraulic unit 40 is operated as described above, the operation is switched from the main hydraulic unit 20 to the pressure-maintaining hydraulic unit 40, that is, the pressure-maintaining hydraulic pump 43 and the pump motor 44 are operated instead of the main hydraulic pump 23 and the pump motor 24 to thereby supply the hydraulic oil from the pressure-maintaining hydraulic pump 43 and the pump motor 44 and thus maintain the pressure of the hydraulic oil in the hydraulic devices in the standby period (hydraulic balance cylinders 18L, 18R, etc). This switching of the operation is automatically performed upon receipt of the stopping instructions (1b) to (5b) mentioned above.

As described above, in the pressure-maintaining control mode, the main hydraulic pump 23 is turned on and the pressure-maintaining hydraulic pump 43 is turned off when one or more of the hydraulic devices that utilize the hydraulic oil are operated, whereas the main hydraulic pump 23 is turned off and the pressure-maintaining hydraulic pump 43 is turned on when all the hydraulic devices that utilize the hydraulic oil are stopped, and the maintaining of the pressure in each hydraulic device in this state is performed by means of the hydraulic oil supplied from the pressure-maintaining hydraulic unit 40.

Moreover, when each hydraulic device is stopped, the main hydraulic unit 20 (pump motor 24) which requires large power consumption is automatically turned off and the pressure-maintaining hydraulic unit 40 (pump motor 44) which requires only small power consumption is automatically turned on. In this way, the power consumption of the machine tool 10 in the standby period can be significantly reduced while the hydraulic balance cylinders 18L, 18R and the like which extend along the gravity axis can still be held clamped as well.

As mentioned above, the pressure-maintaining hydraulic unit 40 can be installed by being connected in parallel to the main hydraulic unit 20 of an existing machine tool. Hence, the power consumption in the standby period can be significantly reduced and energy saving can be achieved even in the case of an existing machine tool which is, for example, an old-model machine tool that has been used for ten years or longer.

In particular, in the case of an old-model existing machine tool, the amount of oil leakage may not be small due to deterioration of hydraulic cylinders in hydraulic circuits, increased leakage from check valves, and the like resulting from the aging. For this reason, even if accumulators are provided, the accumulators may not be able to sufficiently maintain the pressure and unlikely to allow for energy saving. However, by adding the pressure-maintaining hydraulic unit 40 to the existing main hydraulic unit 20 as in the present invention, it is possible to maintain the pressure and also to significantly reduce the power consumption in the standby period and thus achieve energy saving. In this case, it is possible to significantly reduce the power consumption in the standby period and thus achieve energy saving without having to fix the hydraulic cylinders and the like of the old-model machine tool.

Meanwhile, there have been cases where an inverter motor is used as a main hydraulic unit in an attempt to achieve energy saving. However, in the case of a machine tool including hydraulic balance cylinders or the like, oil leakage occurs from hydraulic valves for the pressure balancing. For this reason, the pressure maintaining operation using the inverter motor rarely switches to an energy saving mode, and energy saving cannot be achieved as expected.

Also, in the case of using accumulators, it is desirable to mount the accumulators near hydraulic cylinders which need to maintain the pressure therein. However, mounting accumulators in an existing machine tool is not easy due to the limited space. In the case of a large machine tool, large accumulators need to be mounted at high positions and mounting thereof is therefore not easy either. The present invention, on the other hand, only involves adding the pressure-maintaining hydraulic unit 40 to the existing main hydraulic unit 20, and does not require the mounting of any accumulators. Hence, the present invention can significantly reduce the power consumption in the standby period and thus achieve energy saving through simple work.

Even the present invention cannot avoid oil leakage at the hydraulic balance cylinders 18L, 18R which extend along the gravity axis of the machine tool 10, but the pressure-maintaining hydraulic unit 40 which requires smaller power consumption than the existing main hydraulic unit 20 is actuated to compensate for the leakage. Hence, it is possible to significantly reduce the power consumption in the standby period and thus achieve energy saving.

Here, as machine tools including a balance mechanism, there are a machine tool including a balance mechanism using nitrogen gas (N₂) and a machine tool including a counterweight-type balance mechanism, and they are economically superior to machine tools including a hydraulic balance mechanism. However, the present invention, as a machine tool including a hydraulic balance mechanism, is as economical as these superior machine tools. Further, the present invention is applicable to any machine tools as long as they include a balance mechanism using hydraulic oil and can therefore achieve energy saving while maintaining high accuracy by the balance mechanism.

In addition, it is difficult to apply the balance mechanism using nitrogen gas (N₂) and the counterweight-type balance mechanism to a large and heavy machine tool. However, the present invention achieves energy saving using a hydraulic balance mechanism and can therefore realize a hydraulic balance mechanism in a large and heavy machine tool and achieve energy saving as well.

### INDUSTRIAL APPLICABILITY

The present invention is preferable for large machine tools including hydraulic balance cylinders, for example, a double-column machine tool and the like.

### REFERENCE SIGNS LIST

18L, 18R HYDRAULIC BALANCE CYLINDER

20 MAIN HYDRAULIC UNIT

23 MAIN HYDRAULIC PUMP

24 PUMP MOTOR

27a, 27b PRESSURE SWITCH

40 PRESSURE-MAINTAINING HYDRAULIC UNIT

43 PRESSURE-MAINTAINING HYDRAULIC PUMP

44 PUMP MOTOR

46 PRESSURE SWITCH

1. A pressure maintaining apparatus provided to a main hydraulic apparatus including first supplying means for supplying hydraulic oil to a hydraulic device in an operation period, the pressure maintaining apparatus comprising second supplying means connected in parallel to an oil supply line of the main hydraulic apparatus and being smaller in output than the first supplying means, wherein
instead of the first supplying means, the second supplying means supplies the hydraulic oil to the hydraulic device in a standby period to thereby maintain the pressure of the hydraulic oil in the hydraulic device in the standby period.

2. A machine tool, comprising:
an existing machine tool having a plurality of hydraulic devices including a hydraulic device which needs to maintain pressure of hydraulic oil therein in a standby period and a main hydraulic apparatus including first supplying means for supplying the hydraulic oil to the hydraulic devices in an operation period;
the pressure maintaining apparatus according to claim 1 connected in parallel to an oil supply line of the main hydraulic apparatus.

3. The machine tool according to claim 2, further comprising a controller configured to control the main hydraulic apparatus and the pressure maintaining apparatus, wherein
when any one or more of the plurality of hydraulic devices are operated, the controller stops the second supplying means and operates the first supplying means to thereby supply the hydraulic oil from the first supplying means to the hydraulic devices, and
when all of the plurality of hydraulic devices are stopped, the controller operates the second supplying means instead of the first supplying means to thereby supply the hydraulic oil from the second supplying means to the hydraulic devices and maintain the pressure of the hydraulic oil in the hydraulic devices in the standby period.

4. A machine tool, comprising:
a plurality of hydraulic devices including a hydraulic device which needs to maintain pressure of hydraulic oil therein in a standby period;
a main hydraulic apparatus including first supplying means for supplying the hydraulic oil to the hydraulic devices in an operation period;
a pressure maintaining apparatus connected in parallel to an oil supply line of the main hydraulic apparatus and including second supplying means being smaller in output than the first supplying means; and
a controller configured to control the main hydraulic apparatus and the pressure maintaining apparatus, wherein
when any one or more of the plurality of hydraulic devices are operated, the controller stops the second supplying means and operates the first supplying means to thereby supply the hydraulic oil from the first supplying means to the hydraulic devices, and
when all of the plurality of hydraulic devices are stopped, the controller operates the second supplying means instead of the first supplying means to thereby supply the hydraulic oil from the second supplying means to the hydraulic devices and maintain the pressure of the hydraulic oil in the hydraulic devices in the standby period.

5. A method of running a pressure maintaining apparatus in a machine tool including
a plurality of hydraulic devices including a hydraulic device which needs to maintain pressure of hydraulic oil therein in a standby period,
a main hydraulic apparatus including first supplying means for supplying the hydraulic oil to the hydraulic devices in an operation period, and
a pressure maintaining apparatus connected in parallel to an oil supply line of the main hydraulic apparatus and including second supplying means being smaller in output than the first supplying means, the method comprising:
when any one or more of the plurality of hydraulic devices are operated, stopping the second supplying means and operating the first supplying means to thereby supply the hydraulic oil from the first supplying means to the hydraulic devices; and
when all of the plurality of hydraulic devices are stopped, operating the second supplying means instead of the first supplying means to thereby supply the hydraulic oil from the second supplying means to the hydraulic devices and maintain the pressure of the hydraulic oil in the hydraulic devices in the standby period.
